(19) United States
(12) Patent Application Publication
(10) Pub. No.: US 2005/0143131 A1
(43) Pub. Date: Jun. 30, 2005

(54) Base station processing using SONET links

(76) Inventors: David W. Gish, Riverdale, NJ (US); Arthur E. Sheiman, Mountain Lakes, NJ (US)

Correspondence Address: INTEL CORPORATION, P.O. BOX 5326, SANTA CLARA, CA, 95056-5326, US

(21) Appl. No.: 10/742,207

(22) Filed: Dec. 19, 2003

(51) Int. Cl. H04B 1/38

(52) U.S. Cl. 455/561; 370/314

(57) ABSTRACT

Described are a system and method for processing data received at or to be transmitted through a constituent base station. In one example, a digital signal may be generated based upon an RF signal received at the constituent base station. The digital signal may be encapsulated in data frames for transmission in a SONET circuit to a processing station. The processing station may recover the digital signal from received data frames and perform base-band processing on the recovered digital signal.

### BACKGROUND

1. Field:

The subject matter disclosed herein relates to systems and methods of processing data received by, or to be transmitted to, client devices wirelessly.

2. Information:

Telecommunication data networks typically include a network backbone comprising fiber optic communication links coupling geographically dispersed nodes. Data is typically transmitted across such a network backbone according to the “Synchronous Optical NETwork” (SONET) protocol as indicated in a set of standards provided by the American National Standards Institute (ANSI T1.105.xx) or “Synchronous Digital Hierarchy” (SDH) protocol as indicated in a set of recommendations provided by the International Telecommunications Union (e.g., ITU-T G.707, G. 708, G.709, G.783 and G.784). Under the SONET/SDH protocol, a transmitting node may transmit data frames referred to as “SONET frames” to a destination node.

Cellular wireless communication systems typically communicate with subscribers through the transmission of radio frequency (RF) signals between client devices and a base station. The base station may employ a transceiver to process received RF signals to recover intermediate frequency (IF) signals or base-band signals, and mix IF or base-band signals with RF signals for transmission to client devices. An IF signal recovered from a received RF signal may be further processed for recovering a base-band signal to be provided to a gateway accessing another network such as a public switched telephone network (PSTN). Similarly, a base-band signal received from the gateway may be processed to provide an IF signal for mixing with an RF signal for wireless transmission to one or more client devices. A base station may co-locate a transceiver and an antenna to transmit RF signals to, and receive RF signals from, client devices. Base-band processing equipment can sometimes be geographically separated from a base station and coupled to the base station by a high speed data link.

### BRIEF DESCRIPTION OF THE FIGURES

Non-limiting and non-exhaustive embodiments of the present invention will be described with reference to the following figure, wherein like reference numerals refer to like parts throughout unless otherwise specified.

FIG. 1 shows a communication network that enables client devices to access the network wirelessly.

### DETAILED DESCRIPTION

Reference throughout this specification to “one embodiment” or “an embodiment” means that a particular feature, structure, or characteristic described in connection with the embodiment is included in at least one embodiment of the present invention. Thus, the appearances of the phrase “in one embodiment” or “an embodiment” in various places throughout this specification are not necessarily all referring to the same embodiment. Furthermore, the particular features, structures, or characteristics may be combined in one or more embodiments.

“Machine-readable” instructions as referred to herein relate to expressions which may be understood by one or more machines for performing one or more logical operations. For example, machine-readable instructions may comprise instructions which are interpretable by a processor compiler for executing one or more operations on one or more data objects. However, this is merely an example of machine-readable instructions and embodiments of the present invention are not limited in this respect.

“Machine-readable medium” as referred to herein relates to media capable of maintaining expressions which are perceivable by one or more machines. For example, a machine readable medium may comprise one or more storage devices for storing machine-readable instructions or data. Such storage devices may comprise storage media such as, for example, optical, magnetic or semiconductor storage media. However, these are merely examples of a machine-readable medium and embodiments of the present invention are not limited in these respects.

“Logic” as referred to herein relates to structure for performing one or more logical operations. For example, logic may comprise circuitry which provides one or more output signals based upon one or more input signals. Such circuitry may comprise a finite state machine which receives a digital input and provides a digital output, or circuitry which provides one or more analog output signals in response to one or more analog input signals. Such circuitry may be provided in an application specific integrated circuit (ASIC) or field programmable gate array (FPGA). Also, logic may comprise machine-readable instructions stored in a memory in combination with processing circuitry to execute such machine-readable instructions. However, these are merely examples of structures which may provide logic and embodiments of the present invention are not limited in these respects.

“Synchronous Optical Network” (SONET) as referred to herein relates to a data transmission protocol according to a set of standards provided by the American National Standards Institute (ANSI T1.105.xx). “Synchronous Digital Hierarchy” (SDH) as referred to herein relates to a data transmission protocol according to a set of recommendations provided by the International Telecommunications Union (e.g., ITU-T is G.707, G.708, G.709, G.783 and G.784). “SONET/SDH” as referred to herein relates to aspects of either a SONET or SDH protocol, or both. Hereinafter, “SONET” and “SONET/SDH” may be applied interchangeably.

“Data frames” or “frames” as referred to herein relates to a segment of data which is formatted for transmission from a source to a destination. A data frame 20 may comprise a header portion and a payload portion. A “SONET frame” as referred to herein relates to a data frame formatted for transmission according to a data transmission protocol such as SONET/SDH. However, these are merely examples of a data frame and SONET frame, and embodiments of the present invention are not limited in these respects.

A “SONET link” as referred to herein relates to a data link to transmit SONET frames between nodes. For example, a SONET link may comprise an optical transmission medium coupled between a SONET framer at a transmitting node and a SONET framer at a receiving node. However, this is merely an example of a SONET link and embodiments of the present invention are not limited in these respects.

The data transmission capacity of a data link may be partitioned into a plurality of “time slots” that may be allocated among processes or services. For example, distinct portions of the payload in SONET frames transmitted in a SONET link may be associated with distinct time slots where each time slot is allocated to a distinct service or process. However, these are merely examples of how data transmission capacity of a SONET link may be partitioned into time slots and embodiments of the present invention are not limited in these respects.

A “SONET circuit” as referred to herein relates to a service to transmit data between nodes in a SONET network over shared transmission capacity in one or more shared SONET links. For example, for each SONET link coupling nodes in a SONET circuit, a portion of data transmission capacity may be allocated to the SONET circuit. However, this is merely an example of a SONET circuit and embodiments of the present invention are not limited in this respect. A SONET circuit may be “provisioned” by allocating one or more time slots of one or more SONET links coupling the nodes in the SONET circuit. However, this is merely an example of how a SONET circuit may be provisioned and embodiments of the present invention are not limited in these respects.

A “base station” as referred to herein relates to infrastructure in a communication network that enables clients to access the network wirelessly. For example, a base station may comprise one or more fixed antennas, a transmitter and a receiver to communicate with one or more fixed or mobile client devices wirelessly. However, this is merely an example of a base station and embodiments of the present invention are not limited in this respect.

A “processing station” as referred to herein relates to infrastructure in a communication network to process signals received from one or more client devices wirelessly at a base station, or process signals to be transmitted wirelessly to one or more client devices through a base station. A processing station may comprise circuitry to provide base-band processing to generate an intermediate frequency (IF) signal from a base-band signal, recover a base-band signal from an IF signal, or process base-band signals directly (e.g., independently of an IF conversion). For a particular application to a code division multiple access application, for example, such base-band processing may include chip spreading or dispreading, trellis encoding of symbols for transmission and viterbi decoding for received signals. However, these are merely examples of a processing station, and embodiments of the present invention are not limited in these respects.

A “radio frequency (RF) signal” as referred to herein relates to a signal that is capable of being transmitted as electromagnetic energy. For example, an RF signal may be mixed with a base-band signal or IF signal for transmission or reception through radio waves at an antenna. A base station may comprise a “transmitter” that is capable of mixing an RF signal with a base-band or IF signal for transmission through an antenna. A base station may also comprise a “receiver” which is capable of processing a received RF signal to recover a base-band or IF signal that was mixed with the RF signal. However, these are merely examples of an RF signal, transmitter and receiver, and embodiments of the present invention are not limited in these respects.

A “digital signal” as referred to herein relates to a signal that may be expressed as a series numerical values at discrete time intervals. Such a digital signal may be generated by sampling an analog signal at discrete sample intervals to generate a sample stream of sample values. “Decimation” as referred to herein relates to a process to generate a digital signal based upon a sample stream where the digital signal comprises a sample rate that is lower than a sample rate of the sample stream.

Briefly, an embodiment of the present invention relates to a system and method for processing data received at, or to be transmitted from, a base station. In one example, a digital signal may be generated based upon an RF signal received at the base station. The digital signal may be encapsulated in SONET frames for transmission in a SONET circuit to a processing station. The processing station may recover the digital signal from received data frames and perform base-band processing on the recovered digital signal. In another embodiment, the processing station may encapsulate a digital signal for transmission in a SONET circuit to a base station for transmission as an RF signal. However, these are merely example embodiments and other embodiments are not limited in these respects.

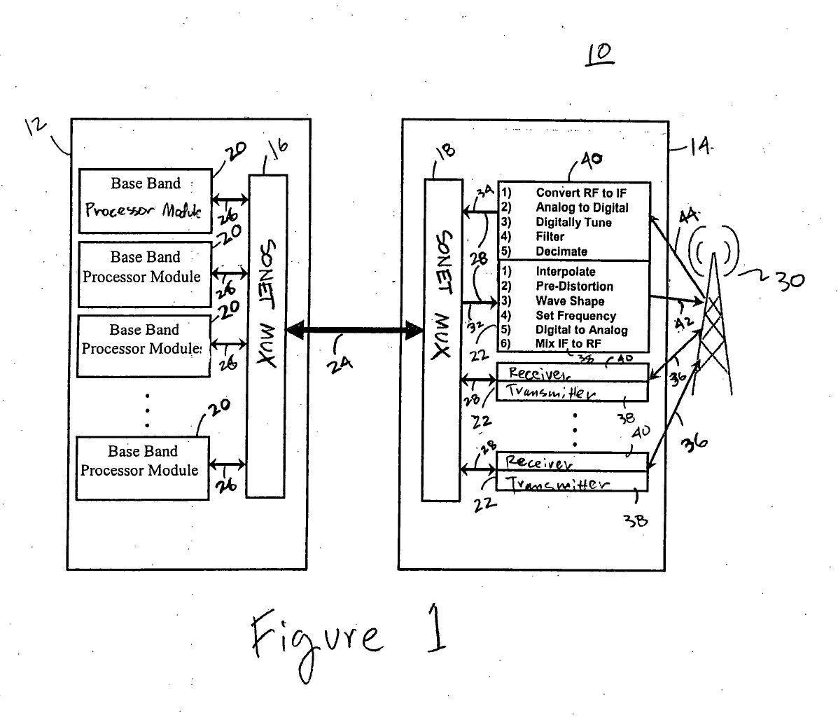

FIG. 1 shows a communication system 10 that enables client devices (not shown) to access a network wirelessly. A constituent base station 14 may be nearby or co-located with an antenna apparatus 30 to transmit or receive RF signals to the client devices wirelessly. The constituent base station 14 may communicate with the client devices using any one of several wireless communication protocols for communication with devices such as, for example, GSM, IS-95, TDMA or xCDMA. The base station 14 also may communicate with client devices using other wireless communication protocols defined by IEEE such as the protocols evolving under IEEE 802.16 working group. However, these are merely examples of how a base station may communicate with client devices wirelessly and embodiments of the present invention are not limited in these respects.

According to an embodiment, the processing station 12 may be coupled to another network by a gateway (not shown) to transmit data between client devices and nodes on the network. The processing station 12 may also be coupled to additional processing equipment (not shown) to control telephone calls and provide voice and/or data paths to another network. For example, the processing station 12 may communicate with nodes on the network through a public switched telephone network (PSTN) gateway, voice over packet gateway, Internet gateway or a proprietary gateway. However, these are merely examples of gateways that may be used to couple a processing station to a network and embodiments of the present invention are not limited in these respects.

The constituent base station 14 may be coupled to a processing station 12 by a SONET link 24 for transmitting digital signals in SONET frames between the base station 14 and processing station 12. The SONET link 24 may comprise one or more physical transmission mediums coupled serially by line terminating equipment. One or more portions of the SONET link 24 may also comprise an aggregation of physical transmission mediums. The SONET link 24 may also comprise one or more portions of a SONET ring topology. However, these are merely examples of how a SONET link may be formed for coupling a base station and a processing station, and embodiments of the present invention are not limited in these respects.

The base station 14 may comprise a plurality of transceiver modules 22 to transmit data to, or receive data from, a client device through an RF signal. Each transceiver module 22 may be coupled to the antenna apparatus 30 by an RF link 36 and comprise a transmitter 38 and a receiver 40. In one embodiment, the antenna apparatus 30 may receive RF signals from client devices and each transceiver module 22 may be allocated to processing an RF signal on an associated one of a plurality of RF carrier frequencies (e.g., where each RF signal comprises a modulated RF carrier signal). Additionally, the antenna apparatus 30 may comprise a plurality of antennas (not shown) where each antenna is allocated to transmitting or receiving one or more of the RF signals. However, this is merely an example of how transceiver modules in a constituent base station may be allocated for processing RF signals received at an antenna apparatus and embodiments of the present invention are not limited in this respect.

According to an embodiment, each transceiver module 22 at the constituent base station 14 may be associated with one or more base-band processing modules 20 at the processing station 12. Correspondingly, each base-band processing module 20 may be allocated for processing one or a plurality of base-band channels to be transmitted over or received from a particular RF signal. Alternatively, multiple transceiver modules 20 may be associated with one base-band processing module 20. Here, a plurality of transceiver modules 22 may be allocated for processing a base-band channel to be transmitted over or received from a plurality of RF signals.

The receiver 40 may convert an RF signal 44 received on an associated RF link 36 to a digital signal to be transmitted to the processing station 12 over the SONET link 24. The receiver 40 may process the RF signal 44 to recover an intermediate frequency (IF) or base-band signal using, for example, a heterodyne receiver (not shown) and sample the IF or a complex base-band signal at an analog to digital conversion circuit (not shown) to generate a stream of samples. The stream of samples may be digitally tuned and filtered to match a specific IF channel as part of the conversion process. The tuned and filtered stream of samples may then be decimated to reduce an effective sample rate of a digital signal to be forwarded to the processing station 12 over the SONET link 24 in SONET frames. However, this is merely an example of how an RF signal may be processed to provide a digital signal for transmission in SONET frames and embodiments of the present invention are not limited in this respect.

The transmitter 38 of a transceiver module 22 may transmit an RF signal 42 to client devices on an RF link 36 responsive to a digital signal received from the processing station 12 in SONET frames over the SONET link 24. The digital signal from the processing station 12 may be representative of an IF signal or modulated by a base-band signal that is addressed to a client device. The transmitter 38 may interpolate between discrete values of the digital signal to provide a stream of values having a higher sample rate than the received digital signal to reduce burden on the capacity of the SONET link 24. In other embodiments, however, the digital signal need not be interpolated. The transmitter 38 may pre-distort, shape and digitally tune the stream of values to linearize high-powered amplifiers. While pre-distortion and shaping may be performed at the base-band processing modules 20, it should be understood that this may result in increased usage of the capacity of the SONET link 24. Nevertheless, in embodiments with sufficient capacity in the SONET link 24, such pre-distortion and/or shaping may be performed in the base-band processing modules 20. The resulting stream of values may then be converted to an analog signal, and the analog signal may be mixed with an RF carrier signal to provide the RF signal 42. However, this is merely an example of how a digital signal received in SONET frames may be processed to provide an RF signal for transmission to client devices and embodiments of the present invention are not limited in this respect.

The processing station 12 may comprise a plurality of base-band processor modules 20 for performing base-band processing on digital signals received from the constituent base station 14 in SONET frames to recover a data signal (e.g., voice, video, Internet packet traffic). The recovered data signal may be forwarded through a gateway as described above. Depending on a particular base-band format being employed, such base-band processing may include performing high-rate processing, symbol rate processing, chip dispreading and/or Viterbi decoding to recover the data signal from the received digital signal. However, these are merely examples of techniques that may be used for base-band processing and embodiments of the present invention are not limited in these respects.

A base-band processor module 20 may also perform base-band processing on data signals received from a gateway for transmission to the constituent base station 14 over the SONET link 24 in SONET frames. A corresponding transceiver module 22 may then process the digital signal received from the SONET frames to one or more client devices as discussed above. Depending on a particular base-band format being employed, such base-band processing may include performing rate processing, symbol rate processing, chip spreading and/or trellis encoding of symbols to generate the digital signal to be forwarded to the base station 14. However, these are merely examples of techniques that may be used for base-band processing and embodiments of the present invention are not limited in these respects.

According to an embodiment, the SONET link 24 may be bi-directionally provisioned to provide a plurality of time division multiplexed SONET links where each SONET link is capable of transporting data for a particular RF or base-band channel. For example, a SONET multiplexer 18 at the base station 14 may couple a plurality of SONET links 28 to the SONET link 24 where each SONET link 28 couples a transceiver module 22 to the multiplexer 18. Similarly, a SONET multiplexer 16 at the processing station 12 may couple a plurality of SONET circuits 26 to the SONET link 24 where each SONET link 26 for each of the base-band processor modules 20. The SONET multiplexers 16 and 18 may couple the SONET links 26 and 28 to the SONET link 24 using byte interleaving to format data from each of a plurality of SONET links in single SONET frame payload for transmission in the SONET link 24 as provided in SONET Basic Description including Multiplex Structure, Rates and Formats, T1.105, Clause 10.1, 2000. While the use of other higher protocol mappings may be used to combine multiple SONET links in a single SONET frame payload (e.g., packet over SONET, generic framing procedure, ATM over SONET, etc.), the SONET multiplexers 16 and 18 may combine SONET circuits into the SONET link 24 or partition SONET circuits from the SONET link 24 at lower latencies by using byte interleaving.

According to an embodiment, the SONET multiplexers 16 and 18 may couple each of the SONET links 28 at the constituent base station 14 with a corresponding SONET link 26 at the processing station 12 through the SONET link 24. The data throughput capacity SONET link 24 may then be sized to accommodate the aggregation of the SONET links at SONET multiplexers 16 and 18. In one embodiment, each of four base-band processor modules 20 at processing station 12 are associated with one of four transceiver modules 22 at the constituent base station 14. However, this is merely an example number of base-band processor modules at a processing station that may be coupled to a corresponding number of and transceiver modules through a SONET link.

In this example, an STS-3c SONET circuit may be provisioned over each pair of corresponding SONET links 26 and 28 coupling a corresponding transceiver module 22 and base-band processor module 20, and over the SONET link 24 having a capacity of OC-12 or higher (e.g., assuming four SONET links 26 or 28 being combined with the SONET link 24). In another embodiment, an STS-12c SONET circuit may be provisioned over each pair of corresponding SONET links 26 and 28 coupling a corresponding transceiver module 22 and base-band processor module 20 and over the SONET link 24 having a capacity of OC-48 or higher (e.g., assuming four SONET links 26 or 28 being combined with the SONET link 24). However, these are merely examples of a data throughput capacity that may be provisioned to a SONET circuit over SONET links coupling corresponding base-band processor modules with transceiver modules, and embodiments of the present invention are not limited in these respects.

According to an embodiment, each of the transceiver modules 22 may be coupled to a corresponding SONET link 28 by a network controller (not shown) such as a SONET framer. Similarly, each of base-band processor modules 20 may be coupled to a corresponding SONET link 26 by a network controller such as a SONET framer. However, these are merely examples of how a SONET circuit may be provisioned over SONET links and embodiments of the present invention are not limited in these respects.

The SONET links 24, 26 and 28 may be configured to have sufficient data throughput to transmit digital signals between transceiver modules 22 at the constituent base station 14 and base-band processor modules 20 at the processing station 12. Based upon a bandwidth of an IF signal (BW_{IF}) recovered at a receiver 40, the IF signal may be sampled at or above the Nyquist sample rate (˜2×BW_{IF}). Sampling above the Nyquist sample rate may improve anti-aliasing and increase the signal to noise ratio associated with the resulting sample stream. Assuming, for the purpose of illustration, BW_{IF}=5 MHz, and a sample rate of between 2×BW_{IF} and 20×BW_{IF}, a sample stream of between 10 and 100 Mega samples would be generated per second. Assuming, again for the purpose of illustration, that each sample generates fourteen bits of data, the resulting sample stream would generate data at 140 to 1400 Mbps.

A SONET link 28 having an OC-3 capacity (capable of provisioning an STS-3c SONET circuit) may transport 155 Mbps and could therefore transport the 140 Mbps resulting from sampling at the Nyquist rate in a SONET STS-3c payload. By generating the digital signal by applying a 10:1 decimation on the 1400 Mbps sample stream, the SONET link 28 may also be sized to have an OC-3 capacity, thereby achieving some benefit from over sampling while using a less costly alternative to an OC-48 SONET link. The SONET links 26 coupled to the base-band processor modules 20 may be similarly sized (e.g., as OC-3 SONET links) to transmit corresponding digital signals to and receive digital signals from counterpart transceiver modules 22.

According to an embodiment, the digital signals transmitted between a transceiver module 22 and a base-band processor module 20 may include latency sensitive control signals. In an embodiment supporting a wideband code division multiple access (WCDMA) protocol, for example, as part of the digital signal transmitted in the SONET link 24, a base-band processor module 20 may forward latency sensitive Power Control (PC) signal to a client device (through an associated transceiver module 22) to control the transmit power at the client device. The PC signal may respond to changes in the received power of an RF signal received from the client device. An application at the base-band processor module 20 may generate the PC signal periodically based upon control data from a transceiver module 22 (e.g., in SONET frames from the SONET link 24) and forward the PC signal to the transceiver module 22 (e.g., in SONET frames transmitted in the SONET link 24) to adjust the transmission power of the client device as part of a power control loop. Given processing latency at the base-band processor module 20, the SONET link 24 and SONET multiplexers 16 and 18 may be configured to forward control signals to meet latency requirements associated with such a control loop, for example, by using the aforementioned byte interleaving technique for multiplexing and demultiplexing the SONET links 26 and 28 over using higher latency packet forwarding mappings (e.g., packet over SONET, generic framing protocol, etc.).

According to an embodiment, the constituent base station 14 and processing station 12 may be owned and operated by a wireless communication service provider while the SONET link 24, or a portion thereof, may be leased by the service provider. By leasing a portion of the SONET link 24 to provision the SONET circuits 26 and 28, the service provide may avoid costly installation, maintenance and operation of a proprietary link coupling the constituent base station 14 and processing station 12. Additionally, the use of a SONET protocol to transmit data between transceiver modules 22 at the constituent base station 14 and base-band processor modules 20 at the processing station 12 over a common SONET link enables the use of standard SONET components such as SONET framers, SONET multiplexers and forward error correction devices.

While there has been illustrated and described what are presently considered to be example embodiments of the present invention, it will be understood by those skilled in the art that various other modifications may be made, and equivalents may be substituted, without departing from the true scope of the invention. Additionally, many modifications may be made to adapt a particular situation to the teachings of the present invention without departing from the central inventive concept described herein. Therefore, it is intended that the present invention not be limited to the particular embodiments disclosed, but that the invention include all embodiments falling within the scope of the appended claims.

1. A method comprising:
generating a digital signal based, at least in part, upon an RF signal received at a constituent base station;
encapsulating the digital signal in data frames for transmission in a SONET circuit to a processing station;
receiving the data frames at the processing station;
recovering the digital signal from the received frames; and
performing base-band processing on the recovered digital signal.

2. The method of claim 1, wherein the SONET circuit comprises a leased portion of a SONET link coupled between the constituent base station and the processing station.

3. The method of claim 1, wherein generating the digital signal further comprises:
converting the RF signal to an IF signal;
sampling the IF signal at discrete sample intervals to provide a sample stream; and
decimating the sample stream to provide the digital signal.

4. The method of claim 1, the method further comprising:
generating a digital signal for each of a plurality of RF signals received at the constituent base station;
for each digital signal generated from an RF signal, encapsulating the digital signal in data frames for transmission in an associated one of a plurality of SONET circuits, each SONET circuit being associated with one of the RF signals; and
multiplexing the SONET circuits for transmission in a SONET link coupled between the constituent base station and the processing station.

5. The method of claim 4, wherein multiplexing the communication channels for transmission in the optical transmission medium further comprises byte interleaving digital signals from the SONET circuits in data frames for transmission in the SONET link.

6. The method of claim 4, the method further comprising receiving each of the RF signals on an RF carrier associated with the RF signal.

7. The method of claim 1, wherein performing base-band processing on the recovered digital signal further comprises chip de-spreading to recover a base-band signal.

8. A system comprising:
an intermediate processing station co-located with a subscriber base station antenna apparatus, the intermediate processing station comprising circuitry to generate a digital signal based upon a radio frequency (RF) signal received at the base station antenna apparatus, and a network controller to encapsulate the digital signal in SONET frames for transmission in a SONET circuit; and
a base-band processing station coupled to the intermediate processing station by a SONET link, the base-band processing station comprising a network controller to recover the digital signal from SONET frames received from the SONET link, and circuitry to perform base-band processing on the recovered digital signal.

9. The system of claim 8, wherein the intermediate processing station further comprises:
a receiver to demodulate the RF signal to recover an intermediate frequency (IF) signal;
circuitry to sample the IF signal at discrete sample intervals; and
circuitry to decimate the sampled IF signal to provide the digital signal.

10. The system of claim 8, wherein the intermediate processing station further comprises:
circuitry to generate a digital signal for each of a plurality of RF signals received at the base station antenna apparatus;
a plurality of network controllers, each network controller being capable of encapsulating the digital signal generated from an associated one of the RF signals into SONET frames for transmission in one of a plurality of SONET circuits, each SONET circuit being associated with a network controller and RF signal; and
a multiplexer to combine the SONET circuits for transmission in the SONET link.

11. The system of claim 10, wherein the multiplexer further comprises circuitry to byte interleave digital signals from the SONET circuits in SONET frames for transmission in the SONET link.

12. The system of claim 10, wherein each of the RF signals is associated with one of a plurality of RF carriers received at the base station antenna apparatus, and wherein intermediate processing station comprises a receiver capable of receiving each of the RF signals on an RF carrier associated with the RF signal.

13. A method comprising:
generating a digital signal based upon a base-band signal received from a network gateway;
encapsulating the digital signal in data frames for transmission in a SONET circuit to a constituent base station;
receiving the data frames at the constituent base station;
recovering the digital signal from the received data frames; and
transmitting an RF signal to one or more client devices based upon the recovered digital signal.

14. The method of claim 13, wherein the SONET circuit comprises a leased portion of a SONET link coupled between the constituent base station and the processing station.

15. The method of claim 13, the method further comprising:
generating a digital signal for each of a plurality of base-band signals received at the processing station;
for each digital signal generated from a base-band signal, encapsulating the digital signal in data frames for transmission in an associated one of a plurality of SONET circuits, each SONET circuit being associated with one of the base-band signals; and
multiplexing the SONET circuits for transmission in a SONET link coupled between the constituent base station and the processing station.

16. The method of claim 15, wherein multiplexing the communication channels for transmission in the optical transmission medium further comprises byte interleaving digital signals from the SONET circuits in data frames for transmission in the SONET link.

17. The method of claim 15, the method further comprising:
receiving each of a plurality of encapsulated digital signal at the constituent base station on a SONET circuit associated with the encapsulated digital signal;
modulating each of a plurality of RF signals based upon the encapsulated digital signal; and
transmitting the modulated RF signals to one or more client devices.

18. A system comprising:
a base-band processing station coupled to one or more network gateways to receive one or more data signals, the base-band processing station comprising circuitry to perform base-band processing on the one or more data signals for generating a digital signal and a network controller to encapsulate the digital signal in frames for transmission in a SONET circuit; and
an intermediate processing station co-located with a subscriber base station antenna apparatus and coupled to the base-band processing station by a SONET link, the intermediate processing station comprising a network controller to recover the digital signal in data frames from the SONET link and circuitry to transmit an RF signal to one or more client devices based upon the recovered digital signal.

19. The system of claim 18, wherein the intermediate processing station further comprises:
circuitry to interpolate between discrete samples of the recovered digital signal to provide a stream of samples;
circuitry to modulate an RF carrier based upon the stream of samples to provide the RF signal; and
a transmitter to transmit the RF signal to the one or more client devices.

20. The system of claim 18, wherein the base-band processing station further comprises:
circuitry to generate a digital signal for each of a plurality of data signals received from one or more network gateways;
for each digital signal generated from a data signal, a network controller to encapsulate the digital signal in data frames for transmission in one of a plurality of SONET circuits to the processing station; and
a multiplexer to combine the SONET circuits for transmission in the SONET link.

21. The system of claim 20, wherein the multiplexer further comprises circuitry to byte interleave digital signals from the SONET circuits in data frames for transmission in the SONET link.
